(19) United States
(12) Patent Application Publication
(10) Pub. No.: US 2026/0093357 A1
(43) Pub. Date: Apr. 2, 2026

(54) ELECTRIC DEVICE AND INPUT SENSING METHOD

(71) Applicants: Samsung Display Co., Ltd., Yongin-si (KR); Research & Business Foundation SUNGKYUNKWAN UNIVERSITY, Suwon-si (KR)

(72) Inventors: KEUMDONG JUNG, Yongin-si (KR); JIHOON KIM, Yongin-si (KR); Kaewon CHOI, Yongin-si (KR); JANGHUI KIM, Yongin-si (KR); Jiyong PARK, Suwon-si (KR); Minjun JEONG, Suwon-si (KR)

(21) Appl. No.: 19/313,554

(22) Filed: Aug. 28, 2025

(30) Foreign Application Priority Data
Sep. 30, 2024 (KR) 10-2024-0132595

(51) Int. Cl. G06F 3/041; G06F 3/044

(52) U.S. Cl. CPC G06F 3/04166; G06F 3/044

(57) ABSTRACT

An electronic device includes: a display unit configured to display an image; a sensor on the display unit; and a sensor driving unit configured to provide a plurality of transmission signals to the sensor and to receive a plurality of sensing signals from the sensor, wherein the sensor driving unit is configured to determine a power flattening phase for equally distributing power of the plurality of transmission signals, to assign the power flattening phase to the plurality of transmission signals, and to provide the plurality of transmission signals to the sensor.

### CROSS-REFERENCE TO RELATED APPLICATION

The present application claims priority to and the benefit of Korean Patent Application No. 10-2024-0132595 filed on Sep. 30, 2024, in the Korean Intellectual Property Office, the entire disclosure of which is incorporated herein by reference.

### BACKGROUND

Aspects of some embodiments of the present disclosure described herein relate to an electronic device that displays images.

Electronic devices such as TVs, mobile phones, tablet personal computers (PCs), navigation systems, game consoles, and the like may display images. In addition to a general input method such as a button, a keyboard, a mouse, or the like, an electronic device may provide a touch-based input method that allows a user to enter information or commands relatively easily and intuitively.

The above information disclosed in this Background section is only for enhancement of understanding of the background and therefore the information discussed in this Background section does not necessarily constitute prior art.

### SUMMARY

Aspects of some embodiments of the present disclosure include an electronic device capable of relatively accurately detecting a user's input and an input sensing method.

According to some embodiments of the present disclosure, an electronic device includes a display unit that displays an image, a sensor on the display unit, and a sensor driving unit that provides a plurality of transmission signals to the sensor and receives a plurality of sensing signals from the sensor, wherein the sensor driving unit determines a power flattening phase for equally distributing power of the plurality of transmission signals, assigns the power flattening phase to the plurality of transmission signals, and provides the plurality of transmission signals to the sensor.

According to some embodiments, the plurality of transmission signals has an identical maximum amplitude.

According to some embodiments, the power flattening phase may be calculated by

$$θ = \{ \begin{matrix}Hadamard ( {2}^{k} ) , & n = 2 k \\ Hadamard ( {2}^{k} ) + iHadamard ( {2}^{k} ) , & n = 2 k + 1\end{matrix} ,$$

where “n” and “k” are each natural numbers, and Hadamard (2^{k}) has a second Hadamard matrix with a size of 2^{k}×2^{k}.

According to some embodiments, the sensor driving unit may calculate a third Hadamard matrix based on a first Hadamard matrix with a size of 2ⁿ×2ⁿ and the second Hadamard matrix and determine a phase of each of the plurality of transmission signals based on the third Hadamard matrix.

According to some embodiments, the third Hadamard matrix with a size of 2³×2³ may be

$$[ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ - 1 & 1 & 1 & - 1 & - 1 & 1 & 1 & - 1 \\ i & i & i & i & i & i & i & i \\ i & - i & i & - i & i & - i & i & - i \\ i & i & - i & - i & i & i & - i & - i \\ - i & i & i & - i & - i & i & i & - i\end{matrix} ] .$$

According to some embodiments, the sensor driving unit may generate an N×N Fourier matrix, calculate a phase shifted matrix by applying a phase shift to each row of the N×N Fourier matrix, generate N simultaneous equations based on the phase shifted matrix, calculate a plurality of power flattening phases based on the N simultaneous equations, and assign the plurality of power flattening phases to the plurality of transmission signals, respectively, to provide the plurality of transmission signals to the sensor.

According to some embodiments, the N×N Fourier matrix is

$$[ \begin{matrix}1 & 1 & 1 & 1 & ⋯ & 1 \\ 1 & {ω}^{1} & {ω}^{2} & {ω}^{3} & ⋯ & {ω}^{N - 1} \\ 1 & {ω}^{2} & {ω}^{4} & {ω}^{6} & ⋯ & {ω}^{2 ( N - 1 )} \\ 1 & {ω}^{3} & {ω}^{6} & {ω}^{9} & ⋯ & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & & {ω}^{( N - 1 ) ( N - 1 )}\end{matrix} ] , where ω = {e}^{\frac{2 π i}{N}} .$$

According to some embodiments, a phase shift value corresponding to each of “N” rows of the N×N Fourier matrix may be

$${phase\_shift}_{k} = cos ( {θ}_{k} ) + i sin ( {θ}_{k} ) for k = 1 , 2 , ⋯ , N .$$

According to some embodiments, the phase shifted matrix is

$$phase\_shifted {\_matrix}_{k} = {\sum }_{j = 1}^{N} {W}_{jk} \cdot {phase\_shift}_{J} for k = 1 , 2 , ⋯ , N ,$$

where “W” is the N×N Fourier matrix, and phase_shiftⱼ is the phase shift value of a j-th row.

According to some embodiments, the sensor driving unit may calculate the plurality of power flattening phases satisfying

$$\vert phase\_shifted {\_matrix}_{1} \vert = \vert phase\_shifted {\_matrix}_{2} \vert = ⋯ ⋯ = \vert phase\_shifted {\_matrix}_{N - 1} \vert = \vert phase\_shifted {\_matrix}_{N} \vert .$$

According to some embodiments, a c-th simultaneous equation of the “N” simultaneous equations is EQc=|phase_shifted_matrixₖ|−\sqrt{N}, where “c” is 1, 2, . . . , N.

According to some embodiments of the present disclosure, an input detecting method of an electronic device includes generating an N×N Fourier matrix, calculating a phase shifted matrix by applying a phase shift to each row of the N×N Fourier matrix, generating N simultaneous equations based on the phase shifted matrix, calculating a plurality of power flattening phases based on the N simultaneous equations, assigning the plurality of power flattening phases to the plurality of transmission signals, respectively, to provide the plurality of transmission signals to a sensor, and receiving sensing signals from the sensor.

According to some embodiments, the N×N Fourier matrix is

$$[ \begin{matrix}1 & 1 & 1 & 1 & ⋯ & 1 \\ 1 & {ω}^{1} & {ω}^{2} & {ω}^{3} & ⋯ & {ω}^{N - 1} \\ 1 & {ω}^{2} & {ω}^{4} & {ω}^{6} & ⋯ & {ω}^{2 ( N - 1 )} \\ 1 & {ω}^{3} & {ω}^{6} & {ω}^{9} & ⋯ & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & & {ω}^{( N - 1 ) ( N - 1 )}\end{matrix} ] , where ω = {e}^{\frac{2 π i}{N}} .$$

According to some embodiments, a phase shift value corresponding to each of “N” rows of the N×N Fourier matrix may be

$${phase\_shift}_{k} = cos ( {θ}_{k} ) + i sin ( {θ}_{k} ) for k = 1 , 2 , ⋯ , N .$$

According to some embodiments, the phase shifted matrix may be

$$phase\_shifted {\_matrix}_{k} = {\sum }_{j = 1}^{N} {W}_{jk} \cdot {phase\_shift}_{J} for k = 1 , 2 , ⋯ , N ,$$

where “W” is the N×N Fourier matrix, and phase_shiftⱼ is the phase shift value of a j-th row.

According to some embodiments, the calculating of the plurality of power flattening phases includes calculating the power flattening phases satisfying

$$\vert phase\_shifted {\_matrix}_{1} \vert = \vert phase\_shifted {\_matrix}_{2} \vert = ⋯ ⋯ = \vert phase\_shifted {\_matrix}_{N - 1} \vert = \vert phase\_shifted {\_matrix}_{N} \vert .$$

According to some embodiments, a c-th simultaneous equation of the “N” simultaneous equations is

$$EQc = \vert phase\_shifted {\_matrix}_{k} \vert - \sqrt{N}$$

where “c” is 1, 2, . . . , N.

### BRIEF DESCRIPTION OF THE FIGURES

The above and other aspects and features of embodiments according to the present disclosure will become more apparent by describing in more detail aspects of some embodiments thereof with reference to the accompanying drawings.

FIG. 1 illustrates an electronic device, according to some embodiments of the present disclosure.

FIG. 2 is a block diagram of an electronic device, according to some embodiments of the present disclosure.

FIG. 3A is a cross-sectional view of an electronic device according to some embodiments of the present disclosure.

FIG. 3B is a cross-sectional view of an electronic device according to some embodiments of the present disclosure.

FIG. 4 is a cross-sectional view of an display device according to some embodiments of the present disclosure.

FIG. 5 is a block diagram of a display unit and a display driving unit, according to some embodiments of the present disclosure.

FIG. 6 is a block diagram of a sensor and a sensor driving unit, according to some embodiments of the present disclosure.

FIG. 7 is a diagram showing an example of a first Hadamard matrix.

FIG. 8 is a diagram showing examples of transmission signals.

FIG. 9 shows an example of the sum of sensing signals.

FIG. 10 is a diagram showing an example of a second Hadamard matrix.

FIG. 11 shows an example of the power flattening phase.

FIG. 12 is a diagram showing an example of a third Hadamard matrix.

FIG. 13 shows an example of the values obtained by adding the elements of the third Hadamard matrix in the column direction.

FIG. 14 shows an example of the sum of transmission signals and sensing signals.

FIG. 15 is a diagram an example of the sum of sensing signals received from a sensor when transmission signals having phases determined based on the third Hadamard matrix are provided to the sensor.

FIG. 16 is a diagram illustrating a Fourier matrix.

FIG. 17 is a flowchart illustrating the operation of a sensor driving unit according to some embodiments of the present disclosure.

FIG. 18A is a diagram showing an example of phase shift values.

FIG. 18B is a diagram showing an example of phases of transmission signals.

FIG. 19 shows an example of the sum of transmission signals and sensing signals.

FIG. 20 is a graph showing an example of a cumulative distribution function for the PAPR of sensing signals.

### DETAILED DESCRIPTION

In the specification, the expression that a first component (or region, layer, part, etc.) is “on”, “connected with”, or “coupled with” a second component means that the first component is directly on, connected with, or coupled with the second component or means that a third component is interposed therebetween.

The same reference numerals refer to the same components. Also, in drawings, the thickness, ratio, and dimension of components are exaggerated for effectiveness of description of technical contents. The term “and/or” includes one or more combinations of the associated listed items.

Although the terms “first”, “second”, etc. may be used to describe various components, the components should not be construed as being limited by the terms. The terms are used only to differentiate one component from another component. For example, without departing the scope of the disclosure, a first component may be referred to as a second component, and similarly, a second component may be referred to as a first component. The articles “a”, “an”, and “the” are singular in that they have a single referent, but the use of the singular form in the specification should not preclude the presence of more than one referent.

Also, the terms “under”, “beneath”, “on”, “above”, etc. are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, aspects of some embodiments of the present disclosure will be described in more detail with reference to accompanying drawings.

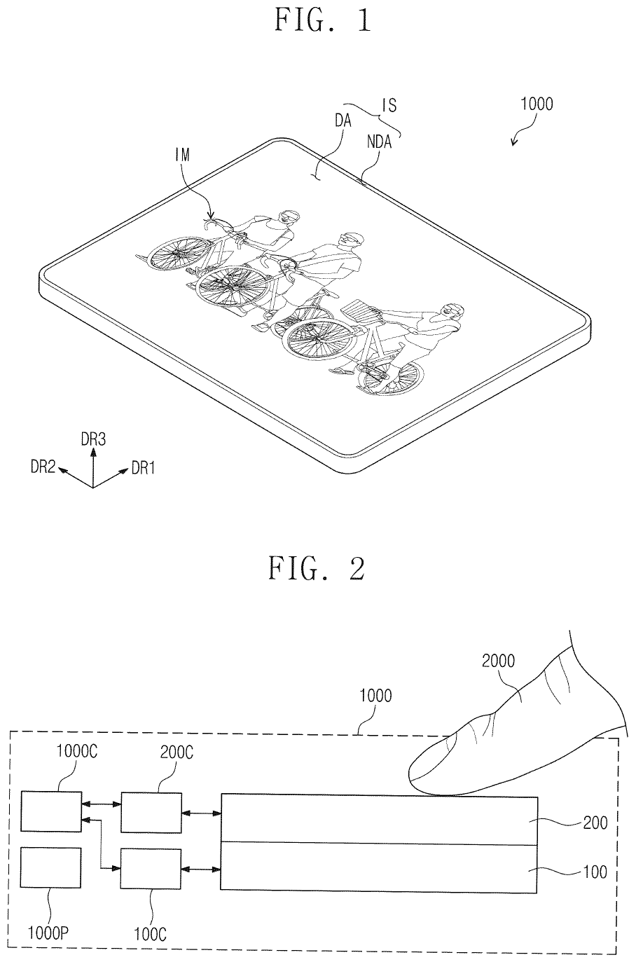

FIG. 1 illustrates an electronic device 1000 according to some embodiments of the present disclosure.

Referring to FIG. 1, the electronic device 1000 may be a device that is activated depending on an electrical signal. The electronic device 1000 may be applied to electronic devices that display images, such as mobile phones, tablets, smart watches, laptops, computers, smart televisions, and navigation devices. In FIG. 1, a mobile phone is illustrated as an example.

The electronic device 1000 may display an image IM on a display surface IS parallel to each of a first direction DR1 and a second direction DR2. The display surface IS on which the image IM is displayed may correspond to a front surface of the electronic device 1000. The image IM may include a still image as well as a moving image. The normal direction of the display surface IS, that is the thickness direction of the electronic device 1000, is indicated by a third direction DR3. A front surface (or an upper surface) and a back surface (or a lower surface) of each layer or unit are divided with respect to the third direction DR3.

The display surface IS of the electronic device 1000 may be divided into a display area DA and a non-display area NDA. The display area DA may refer to an area in which the image IM is displayed. The user visually perceives the image IM through the display area DA. According to some embodiments, the display area DA is illustrated in the shape of a quadrangle whose vertexes are rounded. However, this is illustrated as an example. The display area DA may have various shapes, not limited to any one embodiment.

The non-display area NDA is adjacent to the display area DA. The non-display area NDA may have a given color. The non-display area NDA may surround the display area DA. Accordingly, the shape of the display area DA may be defined substantially by the non-display area NDA. However, this is illustrated as an example. The non-display area NDA may be located adjacent to only one side of the display area DA or may be omitted. The electronic device 1000 according to some embodiments of the present disclosure may include various embodiments and is not limited to any one embodiment.

FIG. 2 is a block diagram of the electronic device 1000 according to some embodiments of the present disclosure.

Referring to FIG. 2, the electronic device 1000 may include a display unit 100, a sensor 200, a display driving unit 100C, a sensor driving unit 200C, a main driving unit 1000C, and a voltage generator 1000P.

The display unit 100 may be a configuration that substantially generates an image. According to some embodiments, the display unit 100 may be referred to as a display layer. The display unit 100 may be a light emitting display layer. For example, the display unit 100 may be an organic light emitting display layer, an inorganic light emitting display layer, an organic-inorganic light emitting display layer, a quantum dot display layer, a micro-LED display layer, or a nano-LED display layer.

The sensor 200 may be located on the display unit 100. The sensor 200 may detect an external input applied from the outside. The sensor 200 may be an integrated sensor formed in the process of manufacturing the display unit 100, or the sensor 200 may be an external sensor attached to the display unit 100.

The main driving unit 1000C may control an overall operation of the electronic device 1000. For example, the main driving unit 1000C may control operations of the display driving unit 100C and the sensor driving unit 200C. The main driving unit 1000C may include at least one microprocessor, and the main driving unit 1000C may also be referred to as a host. The main driving unit 1000C may further include a graphic controller.

The display driving unit 100C may drive the display unit 100. The display driving unit 100C may receive image data and a control signal from the main driving unit 1000C. The control signal may include various signals. For example, the control signal may include an input vertical synchronization signal, an input horizontal synchronization signal, a main clock, a data enable signal, and the like.

According to some embodiments, an input detection device may include the sensor 200 and the sensor driving unit 200C. The sensor driving unit 200C may drive the sensor 200. The sensor driving unit 200C may receive a control signal from the main driving unit 1000C. The control signal may include a clock signal for the sensor driving unit 200C.

The voltage generator 1000P may include a power management integrated circuit (PMIC). The voltage generator 1000P may generate a plurality of driving voltages for driving the display unit 100, the sensor 200, the display driving unit 100C, and the sensor driving unit 200C.

The electronic device 1000 may detect inputs applied from the outside. For example, the electronic device 1000 may detect a passive input caused by a touch 2000. The touch 2000 may include any input means capable of providing a change in electrostatic capacity, such as a user's body or a passive pen.

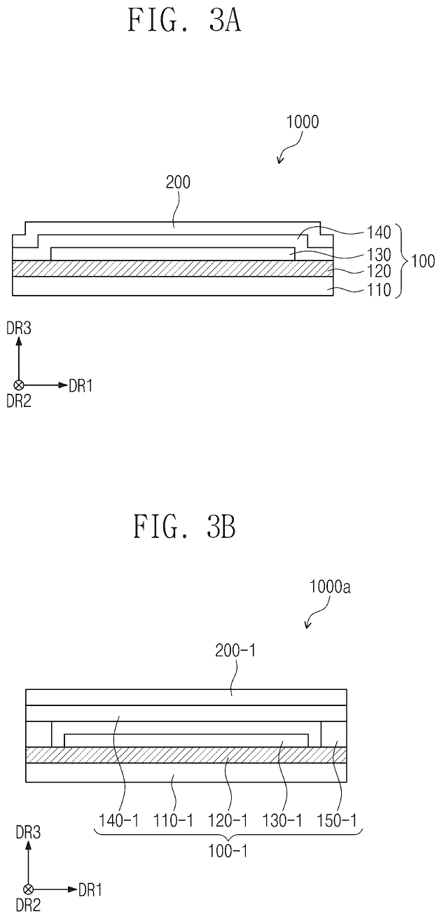

FIG. 3A is a cross-sectional view of the electronic device 1000 according to some embodiments of the present disclosure.

Referring to FIG. 3A, the electronic device 1000 may include the display unit 100 and the sensor 200. The display unit 100 may include a base layer 110, a circuit layer 120, a light emitting element layer 130, and an encapsulation layer 140.

The base layer 110 may be a member that provides a base surface for arranging the circuit layer 120. The base layer 110 may be a glass substrate, a metal substrate, or a polymer substrate. However, embodiments according to the present disclosure are not limited thereto. For example, the base layer 110 may be an inorganic layer, an organic layer, or a composite material layer.

The base layer 110 may have a multi-layer structure. For example, the base layer 110 may include a first synthetic resin layer, a silicon oxide (SiOx) layer located on the first synthetic resin layer, an amorphous silicon (a-Si) layer located on the silicon oxide layer, and a second synthetic resin layer located on the amorphous silicon layer. The silicon oxide layer and the amorphous silicon layer may be referred to as a “base barrier layer”.

The circuit layer 120 may be located on the base layer 110. The circuit layer 120 may include an insulating layer, a semiconductor pattern, a conductive pattern, a signal line, etc. An insulating layer, a semiconductor layer, and a conductive layer may be formed on the base layer 110 through a coating or deposition process, and the insulating layer, the semiconductor layer, and the conductive layer may be selectively patterned through a plurality of photolithography processes. Afterwards, the insulating layer, the semiconductor pattern, the conductive pattern, and the signal line included in the circuit layer 120 may be formed.

The light emitting element layer 130 may be located on the circuit layer 120. The light emitting element layer 130 may include a light emitting element. For example, the light emitting element layer 130 may include an organic light emitting material, an inorganic light emitting material, an organic-inorganic light emitting material, a quantum dot, a quantum rod, a micro-LED, or a nano-LED.

The encapsulation layer 140 may be located on the light emitting element layer 130. The encapsulation layer 140 may protect the light emitting element layer 130 from foreign substances such as moisture, oxygen, and dust particles.

The sensor 200 may be formed on the display unit 100 through a successive process. In this case, it may be expressed that the sensor 200 is directly located on the display unit 100. The expression “being directly located” may mean that a third component is not located between the sensor 200 and the display unit 100. That is, no separate adhesive member may be located between the sensor 200 and the display unit 100. Alternatively, the sensor 200 may be coupled to the display unit 100 through an adhesive member. The adhesive member may include a typical adhesive or a sticking agent.

FIG. 3B is a cross-sectional view of an electronic device 1000a according to some embodiments of the present disclosure.

Referring to FIG. 3B, the electronic device 1000a may include a display unit 100-1 and a sensor 200-1. The display unit 100-1 may include a base substrate 110_1, a circuit layer 120_1, device light emitting element layer 130_1, an encapsulation substrate 140_1, and a coupling member 150_1.

Each of the base substrate 110-1 and the encapsulation substrate 140-1 may be a glass substrate, a metal substrate, or a polymer substrate, but is not specifically limited thereto.

The coupling member 150-1 may be interposed between the base substrate 110-1 and the encapsulation substrate 140-1. The coupling member 150-1 may couple the encapsulation substrate 140-1 to the base substrate 140-1 or the circuit layer 120-1. The coupling member 150-1 may include an inorganic material or an organic material. For example, the inorganic material may include a frit seal, and the organic material may include a photo-curable material or a photo-plastic resin. However, a material constituting the coupling member 150-1 is not limited to the above example.

The sensor 200-1 may be located directly on the encapsulation substrate 140-1. The expression “being directly located” may mean that a third component is not interposed between the sensor 200-1 and the encapsulation substrate 140-1. That is, a separate adhesive member may not be located between the sensor 200-1 and the display unit 100-1. However, embodiments according to the present disclosure are not limited thereto, and an adhesive layer may be additionally located between the sensor 200-1 and the encapsulation substrate 140-1.

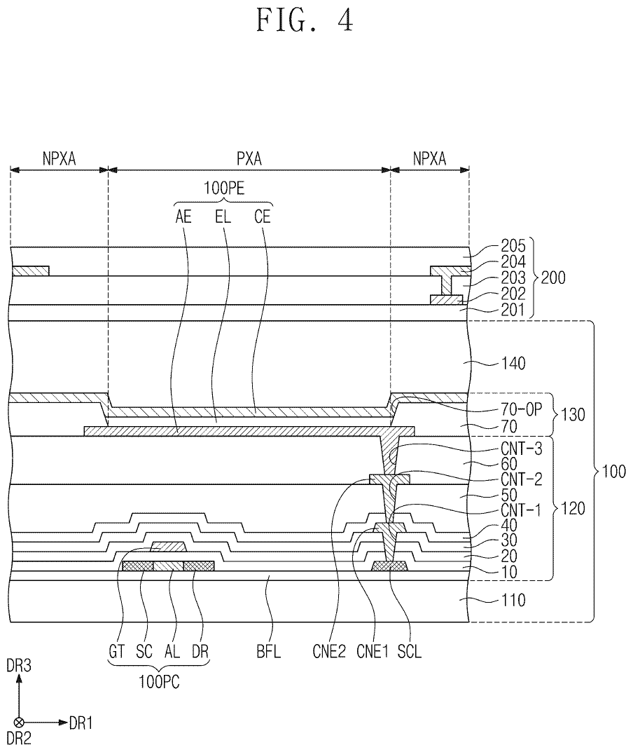

FIG. 4 is a cross-sectional view of a display device, according to some embodiments of the present disclosure. In the description of FIG. 4, the same reference numerals are assigned to the same components described with reference to FIG. 3A, and thus the descriptions thereof are omitted to avoid redundancy.

Referring to FIG. 4, at least one inorganic layer may be formed on an upper surface of the base layer 110. The inorganic layer may include at least one of aluminum oxide, titanium oxide, silicon oxide, silicon oxynitride, zirconium oxide, or hafnium oxide. The inorganic layer may be formed of multiple layers. The multiple inorganic layers may constitute a barrier layer and/or a buffer layer. According to some embodiments, the display unit 100 is illustrated as including a buffer layer BFL.

The buffer layer BFL may relatively improve a bonding force between the base layer 110 and semiconductor patterns. The buffer layer BFL may include a silicon oxide layer and a silicon nitride layer, and the silicon oxide layer and the silicon nitride layer may be alternately stacked.

The semiconductor patterns SC, AL, DR, and SCL may be located on the buffer layer BFL. The semiconductor patterns SC, AL, DR, and SCL may include polysilicon. However, embodiments according to the present disclosure are not limited thereto, and the semiconductor patterns SC, AL, DR, and SCL may include amorphous silicon, low-temperature crystalline silicon, or oxide semiconductor.

FIG. 4 illustrates only the semiconductor patterns SC, AL, DR, and SCL, and a semiconductor pattern may be further located in another area. The semiconductor pattern SC, AL, DR, or SCL may be arranged in a specific rule, across pixels. The semiconductor pattern SC, AL, DR, or SCL may have a different electrical property depending on whether the semiconductor pattern SC, AL, DR, or SCL is doped. The semiconductor patterns SC, AL, DR, and SCL may include the first areas SC, DR, and SCL with high conductivity and the second area AL with low conductivity. The first areas SC, DR, and SCL may be doped with either an N-type dopant or a P-type dopant. A P-type transistor may include a doped area doped with the P-type dopant, and an N-type transistor may include a doped area doped with the N-type dopant. The second area AL may be an undoped area or an area doped with a concentration lower than a concentration in the first areas SC, DR, and SCL.

A conductivity of the first areas SC, DR, and SCL is greater than a conductivity of the second area. The first areas may substantially serve as an electrode or a signal line. The second area AL may substantially correspond to the active area (or channel) of a transistor. In other words, a part of the semiconductor patterns SC, AL, DR, and SCL (e.g., the second area AL) may be the active area AL of a transistor 100PC, another part (for example, the first areas SC and DR) may be the source area SC or the drain region DR of the transistor 100PC, and another part (for example, the first region SCL) may be a connection electrode or the connection signal line SCL.

Each of pixels may include an equivalent circuit including a plurality of transistors, at least one capacitor, and at least one light emitting element, and the equivalent circuit of the pixel may be modified in various forms. One transistor 100PC and one light emitting element 100PE that are included in one pixel are illustrated in FIG. 4 as an example.

The source area SC, the active area AL, and the drain area DR of the transistor 100PC may be formed from the semiconductor patterns SC, AL, DR, and SCL. The source area SC and the drain area DR may extend in directions opposite to each other from the active area AL in a cross-sectional view. FIG. 4 illustrates a portion of the connection signal line SCL formed from the semiconductor patterns SC, AL, DR, and SCL. Although not separately illustrated, the connection signal line SCL may be connected to the drain area DR of the transistor 100PC in a plan view.

A first insulating layer 10 may be located on the buffer layer BFL. The first insulating layer 10 may overlap a plurality of pixels in common and may cover the semiconductor patterns SC, AL, DR, and SCL. The first insulating layer 10 may be an inorganic layer and/or an organic layer, and may have a single-layer or multi-layer structure. The first insulating layer 10 may include at least one of aluminum oxide, titanium oxide, silicon oxide, silicon nitride, silicon oxynitride, zirconium oxide, or a hafnium oxide. According to some embodiments, the first insulating layer 10 may be a silicon oxide layer having a single layer. The first insulating layer 10 and an insulating layer of the circuit layer 120, which is to be described later, may be an inorganic layer and/or an organic layer, and may have a single-layer structure or a multi-layer structure. The inorganic layer may include, but embodiments according to the present disclosure are not limited to, at least one of the above-described materials.

A gate GT of the transistor 100PC is located on the first insulating layer 10. The gate GT may be a part of a metal pattern. The gate GT overlaps the active area AL. In the process of doping or reducing semiconductor patterns SC, AL, DR, and SCL, the gate GT may function as a mask.

A second insulating layer 20 may be located on the first insulating layer 10 and may cover the gate GT. The second insulating layer 20 may overlap the pixels in common. The second insulating layer 20 may be an inorganic layer and/or an organic layer, and may have a single layer structure or a multi-layer structure. The second insulating layer 20 may include at least one of silicon oxide, silicon nitride, or silicon oxynitride. According to some embodiments, the second insulating layer 20 may have a multi-layer structure including a silicon oxide layer and a silicon nitride layer.

The third insulating layer 30 may be located on the second insulating layer 20. The third insulating layer 30 may have a single-layer or multi-layer structure. For example, the third insulating layer 30 may have a multi-layer structure including a silicon oxide layer and a silicon nitride layer.

A first connection electrode CNE1 may be located on the third insulating layer 30. The first connection electrode CNE1 may be connected with the connection signal line SCL through a contact hole CNT-1 formed through the first insulating layer 10, the second insulating layer 20, and the third insulating layer 30.

A fourth insulating layer 40 may be located on the third insulating layer 30. The fourth insulating layer 40 may be a single silicon oxide layer. A fifth insulating layer 50 may be located on the fourth insulating layer 40. The fifth insulating layer 50 may be an organic layer.

A second connection electrode CNE2 may be located on the fifth insulating layer 50. The second connection electrode CNE2 may be connected with the first connection electrode CNE1 through a contact hole CNT-2 penetrating the fourth insulating layer 40 and the fifth insulating layer 50.

A sixth insulating layer 60 may be located on the fifth insulating layer 50 and may cover the second connection electrode CNE2. The sixth insulating layer 60 may be an organic layer.

The light emitting element layer 130 may be located on the circuit layer 120. The light emitting element layer 130 may include the light emitting element 100PE. For example, the light emitting element layer 130 may include an organic light emitting material, an inorganic light emitting material, an organic-inorganic light emitting material, a quantum dot, a quantum rod, a micro-LED, or a nano-LED. Below, an example in which the light emitting element 100PE is an organic light emitting element will be described, but the light emitting element 100PE is not specifically limited thereto.

The light emitting element 100PE may include a first electrode AE, a light emitting layer EL, and a second electrode CE. The first electrode AE may be located on the sixth insulating layer 60. The first electrode AE may be connected with the second connection electrode CNE2 through a contact hole CNT-3 penetrating the sixth insulating layer 60.

A pixel defining film 70 may be located on the sixth insulating layer 60 and may cover a portion of the first electrode AE. An opening 70-OP is defined in the pixel defining film 70. The opening 70-OP of the pixel defining film 70 exposes at least a portion of the first electrode AE.

The display area IS (see FIG. 1) may include a light emitting area PXA and a non-light emitting area NPXA adjacent to the light emitting area PXA. The non-light emitting area NPXA may surround the light emitting area PXA. According to some embodiments, the light emitting area PXA is defined to correspond to the portion of the first electrode AE, which is exposed by the opening 70-OP.

The light emitting layer EL may be located on the first electrode AE. The light emitting layer EL may be located in an area defined by the opening 70-OP. In FIG. 4, an example is shown in which the light emitting layer EL is located within the opening 70-OP, but embodiments according to the present disclosure are not limited thereto. For example, the light emitting layer EL may extend to cover a portion of a side surface of the pixel defining film 70 defining the opening 70-OP and a top surface of the pixel defining film 70.

According to some embodiments of the present disclosure, the light emitting layer EL may be separately formed on each of pixels. In the case where the light emitting layer EL is independently located for each pixel, each of the light emitting layers EL may emit a light of at least one of a blue color, a red color, or a green color. However, embodiments according to the present disclosure are not limited thereto, and the light emitting layer EL may be connected to and included in the pixels in common. In this case, the light emitting layer EL may provide a blue color or may provide a white color.

The second electrode CE may be located on the light emitting layer EL. The second electrode CE may be integrally formed and included in a plurality of pixels in common.

According to some embodiments of the present disclosure, a hole control layer may be interposed between the first electrode AE and the light emitting layer EL. The hole control layer may be located in common in the light emitting area PXA and the non-light emitting area NPXA. The hole control layer may include a hole transport layer and may further include a hole injection layer. An electron control layer may be located between the light emitting layer EL and the second electrode CE. The electron control layer may include an electron transport layer and may further include an electron injection layer. The hole control layer and the electron control layer may be formed in common in a plurality of pixels by using an open mask or or inkjet process.

The encapsulation layer 140 may be located on the light emitting element layer 130. The encapsulation layer 140 may include an inorganic layer, an organic layer, and an inorganic layer sequentially stacked, and layers constituting the encapsulation layer 140 are not limited thereto. The inorganic layers may protect the light emitting element layer 130 from moisture and oxygen, and the organic layer may protect the light emitting element layer 130 from a foreign material such as dust particles. The inorganic layers may include a silicon nitride layer, a silicon oxynitride layer, a silicon oxide layer, a titanium oxide layer, an aluminum oxide layer, or the like. The organic layer may include an acrylic-based organic layer but embodiments according to the present disclosure are not limited thereto.

The sensor 200 may include a base insulating layer 201, a first conductive layer 202, an intermediate insulating layer 203, a second conductive layer 204, and a cover insulating layer 205.

The base insulating layer 201 may be an inorganic layer including at least one of silicon nitride, silicon oxynitride, or silicon oxide. Alternatively, the base insulating layer 201 may be an organic layer including an epoxy resin, an acrylic resin, or an imide-based resin. The base insulating layer 201 may have a single-layer structure or may be a multi-layer structure in which a plurality of layers are stacked along the third direction DR3.

Each of the first conductive layer 202 and the second conductive layer 204 may have a single layer structure or a multi-layer structure stacked in the third direction DR3.

Each of the first conductive layer 202 and the second conductive layer 204 that have a single-layer structure may include a metal layer or a transparent conductive layer. The metal layer may include molybdenum, silver, titanium, copper, aluminum, or the alloy thereof. The transparent conductive layer may include a transparent conductive oxide such as indium tin oxide (ITO), indium zinc oxide (IZO), zinc oxide (ZnO), or indium zinc tin oxide (IZTO). Additionally, the transparent conductive layer may include conductive polymers such as poly(3,4-ethylenedioxythiophene) (PEDOT), metal nanowires, graphene, and the like.

Each of the first conductive layer 202 and the second conductive layer 204 that have a multi-layer structure may include metal layers. The metal layers may have a three-layer structure of titanium/aluminum/titanium. The conductive layer of the multi-layer structure may include at least one metal layer and at least one transparent conductive layer.

According to some embodiments of the present disclosure, the thickness of the first conductive layer 202 may be greater than or equal to the thickness of the second conductive layer 204. When the thickness of the first conductive layer 202 is greater than the thickness of the second conductive layer 204, the resistance of components included in the first conductive layer 202 (e.g., electrodes, sensing patterns, or bridge patterns, etc.) may be relatively reduced. Moreover, because the first conductive layer 202 is located under the second conductive layer 204, the probability that components included in the first conductive layer 202 are to be recognized by external light reflection may be lower than that of the second conductive layer 204, even though the thickness of the first conductive layer 202 is increased.

At least one of the intermediate insulating layer 203 or the cover insulating layer 205 may include an inorganic film. The inorganic film may include at least one of aluminum oxide, titanium oxide, silicon oxide, silicon nitride, silicon oxynitride, zirconium oxide, or hafnium oxide.

At least one of the intermediate insulating layer 203 or the cover insulating layer 205 may include an organic film. The organic film may include at least one of acrylate-based resin, methacrylate-based resin, polyisoprene-based resin, vinyl-based resin, epoxy-based resin, urethane-based resin, cellulose-based resin, siloxane-based resin, polyimide-based resin, polyamide-based resin, or perylene-based resin.

Previously, the description will be given under the condition that the sensor 200 includes a total of two conductive layers (i.e., the first conductive layer 202 and the second conductive layer 204), but embodiments according to the present disclosure are not particularly limited thereto. For example, the sensor 200 may include three or more conductive layers.

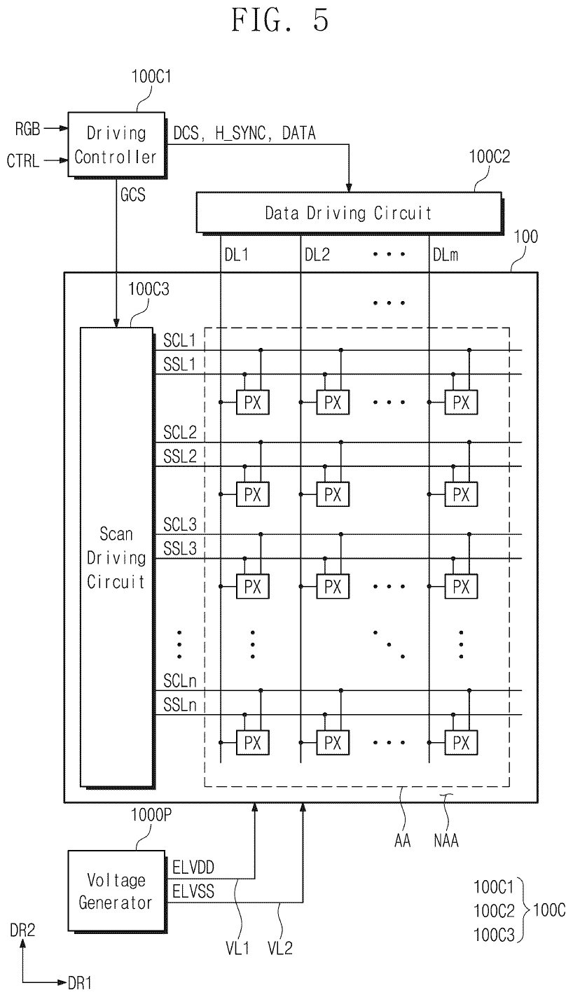

FIG. 5 is a block diagram of the display unit 100 and the display driving unit 100C, according to some embodiments of the present disclosure.

Referring to FIG. 5, the display driving unit 100C may include a driving controller 100C1, a data driving circuit 100C2, and a scan driving circuit 100C3.

The display unit 100 may include driving scan lines SCL1, SCL2, SCL3, . . . , SCLn, sensing scan lines SSL1, SSL2, SSL3, . . . , SSLn, data lines DL1, DL2, . . . , DLm, and pixels PX. Here, “n” and “m” are each an integer greater than or equal to 1. The display unit 100 may be divided into an active area AA and an inactive area NAA. The pixels PX may be positioned in the active area AA of the display unit 100. The scan driving circuit 100C3 may be positioned in the inactive area NAA.

The driving scan lines SCL1, SCL2, SCL3, . . . , SCLn and the sensing scan lines SSL1, SSL2, SSL3, . . . , SSLn may extend parallel to the first direction DR1 and may be spaced apart from each other in the second direction DR2. The second direction DR2 may be a direction crossing the first direction DR1. The data lines DL1, DL2, . . . , DLm may extend parallel to the second direction DR2 and may be spaced apart from each other in the first direction DR1.

The plurality of pixels PX may be electrically connected to the driving scan lines SCL1, SCL2, SCL3, . . . , SCLn, the sensing scan lines SSL1, SSL2, SSL3, . . . , SSLn, and the data lines DL1, DL2, . . . , DLm, respectively. Each of the plurality of pixels PX may be electrically connected to two scan lines. It should be noted that the number of scan lines connected with each pixel PX is not limited thereto. For example, each of the plurality of pixels PX may be electrically connected to one or three scan lines. The display unit 100 may extend in the second direction DR2 and may further include read-out lines (also referred to as sensing lines) arranged in the first direction DR1. In this case, the plurality of pixels PX may be connected to the read-out lines.

Each of the plurality of pixels PX may include a light emitting element and a pixel circuit unit that controls light emission of the light emitting element. The light emitting element may include an organic light emitting diode, an inorganic light emitting diode, a micro LED, or a nano LED. The pixel circuit unit may include a plurality of transistors and at least one capacitor.

The driving controller 100C1 may receive an input image signal RGB and a control signal CTRL from the main driving unit 1000C (see FIG. 2). The driving controller 100C1 may generate image data DATA through conversion of the input image signal RGB.

The driving controller 100C1 may generate a scan control signal GCS, a data control signal DCS, and a horizontal synchronization signal H_SYNC based on the control signal CTRL. The data driving circuit 100C2 may receive the data control signal DCS, the horizontal synchronization signal H_SYNC, and the image data DATA from the driving controller 100C1. The data driving circuit 100C2 may convert the image data DATA into data voltages (also referred to as data signals) in response to the data control signal DCS and the horizontal synchronization signal H_SYNC. The data driving circuit 100C2 may output the data voltages to the plurality of data lines DL1, DL2, . . . , DLm. The data voltages may be analog voltages corresponding to grayscale values of the image data DATA.

In one example of the present disclosure, the data driving circuit 100C2 may be formed in the form of at least one chip (or integrated circuit). The data driving circuit 100C2 may be located in the inactive area NAA of the display unit 100, but embodiments according to the present disclosure are not limited thereto. For example, the data driving circuit 100C2 may be mounted on a circuit film connected to the display unit 100.

The scan driving circuit 100C3 may receive the scan control signal GCS from the driving controller 100C1. The scan driving circuit 100C3 may output scan signals in response to the scan control signal GCS. The scan driving circuit 100C3 may be embedded in the display unit 100. When the scan driving circuit 100C3 is embedded in the display unit 100, the scan driving circuit 100C3 may include transistors formed by the same process as each pixel PX. The scan driving circuit 100C3 may be located in the inactive area NAA of the display unit 100, but embodiments according to the present disclosure are not limited thereto. According to some embodiments, at least a portion of the scan driving circuit 100C3 may overlap the active area AA of the display unit 100.

The scan driving circuit 100C3 may generate a plurality of driving scan signals and a plurality of sensing scan signals in response to the scan control signal GCS. The plurality of driving scan signals may be applied to the driving scan lines SCL1, SCL2, SCL3, . . . , SCLn, and the plurality of sensing scan signals may be applied to the sensing scan lines SSL1, SSL2, SSL3, . . . , SSLn.

Each of the plurality of pixels PX may receive a first driving voltage ELVDD and a second driving voltage ELVSS.

The voltage generator 1000P may generate voltages required for operation of the display unit 100. According to some embodiments of the present disclosure, the voltage generator 1000P generates the first driving voltage ELVDD and the second driving voltage ELVSS required for operation of the display unit 100. The first driving voltage ELVDD and the second driving voltage ELVSS may be provided to the display unit 100 via a first driving voltage line VL1 and a second driving voltage line (VL2.

The voltage generator 1000P may further generate the first driving voltage ELVDD and the second driving voltage ELVSS, as well as various other voltages required for operation of the data driving circuit 100C2 and the scan driving circuit 100C3 (e.g., a gamma reference voltage, a data drive voltage, a gate-on voltage, and a gate-off voltage).

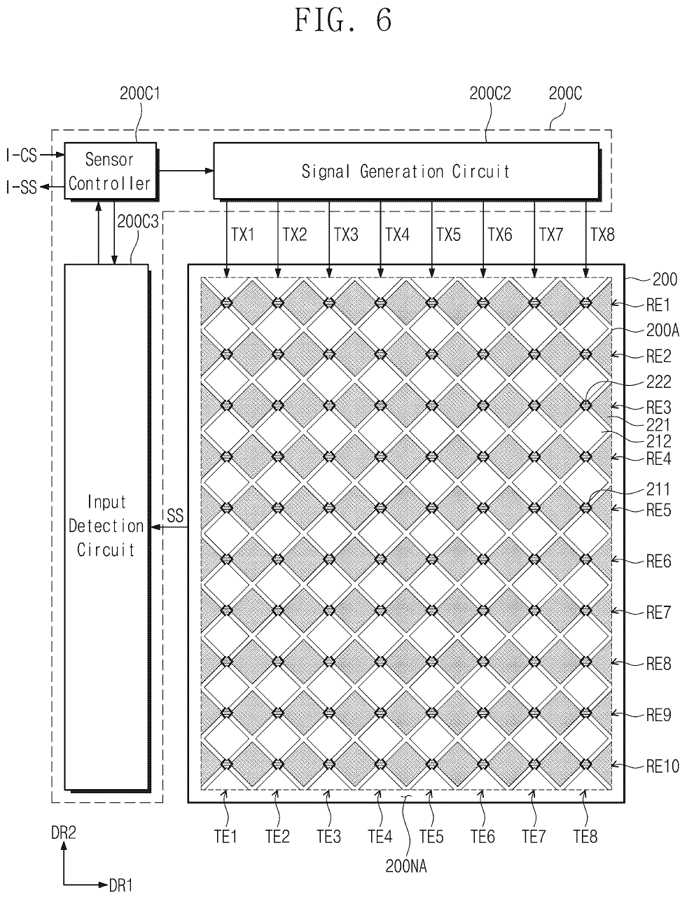

FIG. 6 is a block diagram of the sensor 200 and the sensor driving unit 200C, according to some embodiments of the present disclosure.

Referring to FIG. 6, in the sensor 200, an active sensing area 200A and an inactive sensing area 200NA may be defined. The active sensing area 200A may be an area activated depending on an electrical signal. For example, the active sensing area 200A may be an area for detecting an input. The active sensing area 200A may overlap the active area AA (see FIG. 5) of the display unit 100 (see FIG. 5). The inactive sensing area 200NA may surround the active sensing area 200A. For example, the inactive sensing area 200NA may be an area in which an input is not detected. The inactive sensing area 200NA may overlap the inactive area NAA (see FIG. 5) of the display unit 100 (see FIG. 5).

The sensor 200 may include first electrodes TE1 to TE8 (or, referred to as transmission electrodes) and second electrodes RE1 to RE10 (or, referred to as reception electrodes). Each of the first electrodes TE1 to TE8 may extend in the second direction DR2. The first electrodes TE1 to TE8 may be arranged spaced from each other in the first direction DR1. Each of the second electrodes RE1 to RE10 may extend in the first direction DR1. The second electrodes RE1 to RE10 may be arranged spaced from each other in the second direction DR2.

The sensor 200 in FIG. 6 is illustrated as including eight first electrodes TE1 to TE8 and ten second electrodes RE1 to RE10, but embodiments according to the present disclosure are not limited thereto. The number of the first electrodes and the number of second electrodes may be variously changed.

The sensor 200 may further include a plurality of first signal wires (or first trace wires) connected to the first electrodes TE1 to TE8 and a plurality of second signal wires (or second trace wires) connected to the second electrodes RE1 to RE10.

Each of the first electrodes TE1 to TE8 may include a first sensing portion 211 and a bridge portion 212. The first sensing portions 211 adjacent to each other may be electrically connected by the bridge portion 212, but the present disclosure is not particularly limited thereto. The first sensing portion 211 and the bridge portion 212 may be arranged in different layers.

Each of the second electrodes RE1 to RE10 may include a second sensing portion 221 and a connection portion 222. The second sensing portion 221 and the connection portion 222 may have an integrated shape and may be arranged in the same layer. Each of the first electrodes TE1 to TE8 may have a mesh shape, and each of the second electrodes RE1 to RE10 may have a mesh shape.

The first sensing portion 211, the second sensing portion 221, the bridge portion 212, and the connection portion 222 may include a metal layer. Each of the first sensing portion 211, the second sensing portion 221, the bridge portion 212, and the connection portion 222 may have a mesh shape.

The sensor driving unit 200C may receive a control signal I-CS from the main driving unit 1000C (see FIG. 2) and provide a coordinate signal I-SS to the main driving unit 1000C (see FIG. 2).

The sensor driving unit 200C may include a sensor controller 200C1, a signal generation circuit 200C2, and an input detection circuit 200C3. The sensor controller 200C1, the signal generation circuit 200C2, and the input detection circuit 200C3 may be implemented in a single chip. Alternatively, a part of the sensor controller 200C1, the signal generation circuit 200C2, and the input detection circuit 200C3, and another part thereof may be implemented in different chips from each other.

The sensor controller 200C1 may control an operation of the signal generation circuit 200C2, and calculate coordinates of an external input from a sensing signal received from the input detection circuit 200C3.

The signal generation circuit 200C2 may output transmission signals TX1 to TX8 (or transmission signals) to the sensor 200, for example, the first electrodes TE1 to TE8. The signal generation circuit 200C2 may output the transmission signals TX1 to TX8 corresponding to an operation mode to the sensor 200.

The input detection circuit 200C3 may receive sensing signals SS from the sensor 200, for example, the second electrodes RE1 to RE10. The input detection circuit 200C3 may convert an analog signal to a digital signal. For example, the input detection circuit 200C3 may amplify and filter the received sensing signals SS in analog form, and convert the filtered signals to digital signals.

The sensor controller 200C1 may generate the coordinate signal I-SS based on the digital signals received from the input detection circuit 200C3. Specifically, the sensor controller 200C1 may generate the coordinate signal I-SS using the digital signals described above.

The sensor controller 200C1 may determine an operation mode based on the digital signals received from the input detection circuit 200C3. According to some embodiments, the sensor controller 200C1 may determine one of a touch detection mode and a pen detection mode as the operation mode.

One important consideration in designing the sensor driving unit 200C is the peak to average power ratio (PAPR) of the sensing signals SS. PAPR refers to the ratio of the peak values to the average values of the sensing signals SS. PAPR may be expressed as Equation 1.

$$PAPR = 10 {log}_{10} \frac{{max}_{0 \leq t \leq T} {s ( t )}^{2}}{\frac{1}{T} {\int }_{0}^{T} {s ( t )}^{2} dt} \qquad Equation 1$$

where “T” may be the number of sensing signals SS, i.e., the number of second electrodes RE1 to RE10. For example, in the example shown in FIG. 6, T=10.

An increase in the PAPR of the sensing signals SS means an increase in the dynamic range of the sensing signals SS, which causes a decrease in the precision of an analog-to-digital converter in the input detection circuit 200C3. Furthermore, when the peak values of the sensing signals SS are outside the measurement range of the analog-to-digital converter, it may cause signal distortion due to clipping of the sensing signals SS.

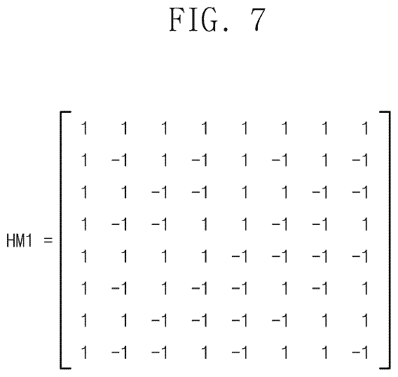

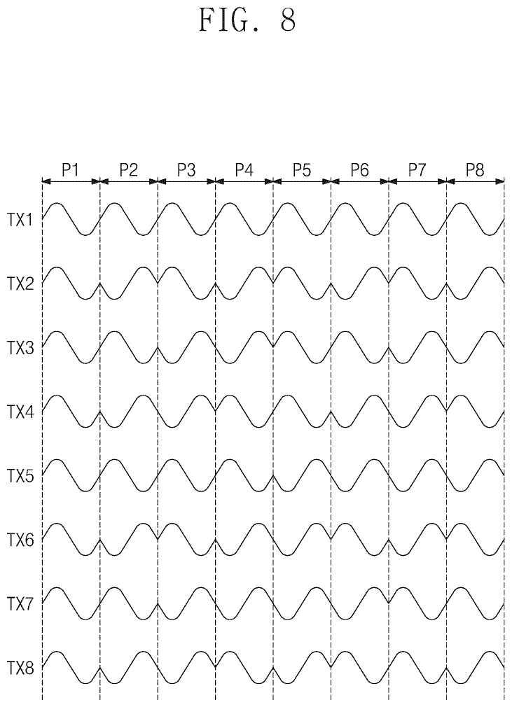

FIG. 7 is a diagram showing an example of a first Hadamard matrix HM1.

FIG. 8 is a diagram showing examples of transmission signals TX1 to TX8.

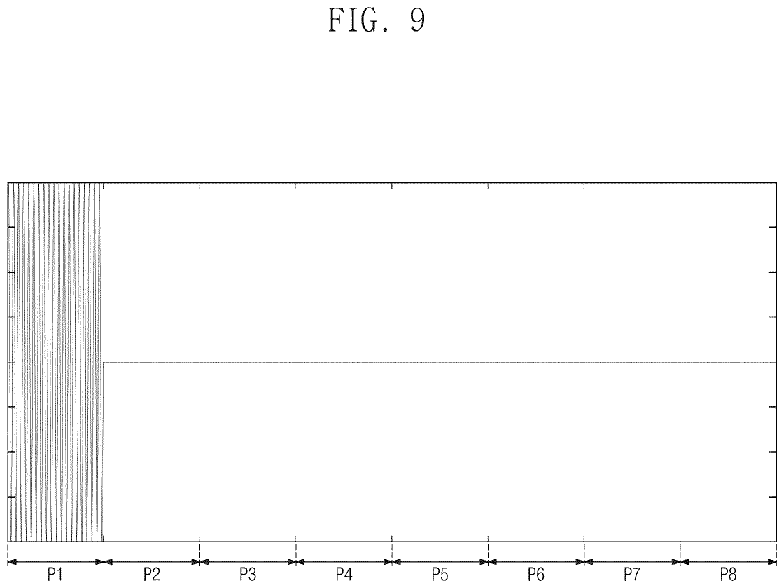

FIG. 9 illustrates an example of an sum of sensing signals SS.

Referring to FIGS. 6, 7, and 8, the Hadamard matrix HM1 has a size of 8×8.

The sensor controller 200C1, employing code division multiplexing (CDM) or a multiple frequency driving method (MC-MFDM), may multiply the first Hadamard matrix HM1 shown in FIG. 7 by a predetermined waveform (e.g., a sine waveform) to output the transmission signals TX1 to TX8 shown in FIG. 8.

According to the value of the first Hadamard matrix HM1, the phase of each of the transmission signals TX1 to TX8 in the first to eighth sections P1 to P8 is determined. The transmission signals TX1 to TX8 may be provided to the first electrodes TE1 to TE8 shown in FIG. 6, respectively.

When the signal generation circuit 200C2 provides the transmission signals TX1 to TX8 to the first electrodes TE1 to TE8, the input detection circuit 200C3 may receive the sensing signals SS as shown in FIG. 9.

In FIG. 9, the horizontal axis represents time, and the vertical axis represents amplitude. Because the transmission signals TX1 to TX8 (see FIG. 6) in the first section P1 have the same amplitude and phase, the sum of the sensing signals SS in the first section P1 may have a very large amplitude. In other words, the PAPR of the sum of the sensing signals SS in the first section P1 may have a very large value.

The sensor controller 200C1 according to some embodiments of the present disclosure may perform power flattening on the transmission signals TX1 to TX8 to minimize the PAPR of the sensing signals SS.

The power flattening phase (θ) for the first Hadamard matrix HM1 with a size of 2ⁿ×2ⁿ is defined as shown in Equation 2.

$$θ = \{ \begin{matrix}Hadamard ( {2}^{k} ) , & n = 2 k \\ Hadamard ( {2}^{k} ) + iHadamard ( {2}^{k} ) , & n = 2 k + 1\end{matrix} \qquad Equation 2$$

where, n and k are natural numbers.

Hadamard (2^{k}) may represent a second Hadamard matrix HM2 with a size of 2^{k}×2^{k}.

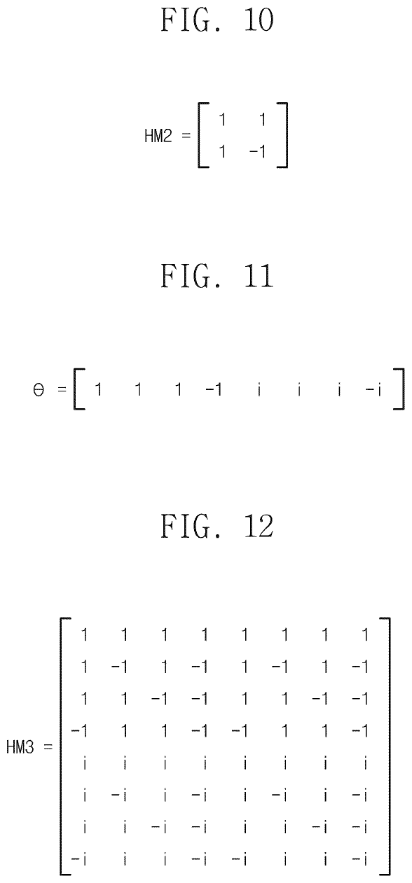

FIG. 10 shows an example of the second Hadamard matrix HM2.

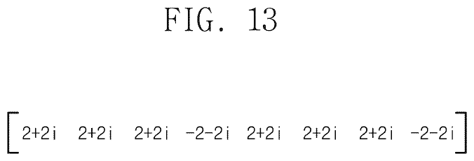

FIG. 11 shows an example of a power flattening phase θ.

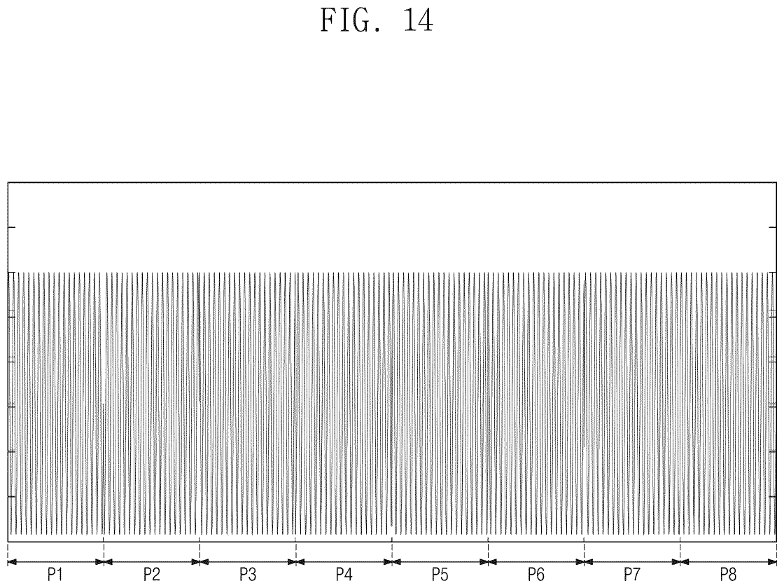

FIG. 12 shows an example of a third Hadamard matrix HM3.

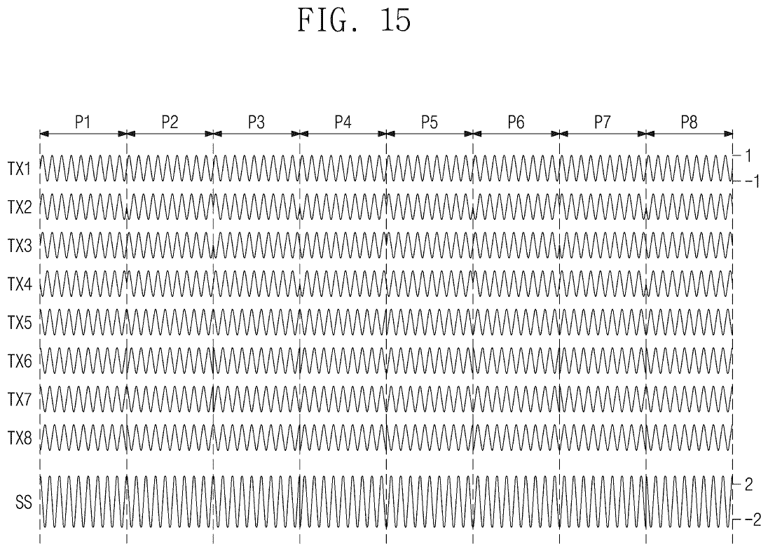

FIG. 13 shows an example of a value obtained by adding the elements of the third Hadamard matrix HM3 in the column direction.

For example, when the number of transmission signals TX1 to TX8 (see FIG. 6) is 8 (=23), the size of the first Hadamard matrix HM1 is 8×8. To find the power flattening phase of the first Hadamard matrix HM1 with a size of 8×8, the second Hadamard matrix HM2 may have a size of 2×2, as shown in FIG. 10 due to n=3 and k=1 in Equation 2.

The power flattening phase θ, which lists the elements of the 2×2 Hadamard matrix multiplied by the complex number “i” according to Equation 2, is shown in FIG. 11.

The third Hadamard matrix HM3 may be obtained by multiplying each of rows of the first Hadamard matrix HM1 shown in FIG. 7 by the power flattening phase θ yields as shown in FIG. 12. Here, due to the orthogonal nature of the Hadamard matrix, the orthogonality between the transmission signals TX1 to TX8 (see FIG. 6) may be preserved even when the rows are multiplied by different values.

The column-wise sum of the elements of the third Hadamard matrix HM3 shown in FIG. 12 produces the result shown in FIG. 13.

Referring to FIG. 13, it can be seen that the sums of the first through eighth columns of the third Hadamard matrix HM3 are equal in magnitude and out of phase with each other.

In other words, assigning the power flattening phase θ of Equation 2 to the code comprising the first Hadamard matrix HM1 allows the same power to be distributed among the transmission signals TX1 to TX8 (see FIG. 6) in all cases, which is independent of the frequency of the transmission signals TX1 to TX8. That is, the amplitudes of the transmission signals TX1 to TX8 are the same as each other.

When the amplitudes of the transmission signals TX1 to TX8 are fixed, the PAPR of the sensing signals SS has a minimum value (e.g., 3 dB) because a fixed phase shift is applied without additional calculation on the Hadamard matrix. Therefore, both a low computational complexity in calculating the phases of the transmission signals TX1 to TX8 and an optimal PAPR may be satisfied.

The sensor driving unit 200C may determine the phases of the transmission signals TX1 to TX8 based on the third Hadamard matrix HM3.

According to some embodiments, when the number of transmission signals TX1 to TX8 is a multiple of 4 (2ⁿ), the sensor driving unit 200C may determine the phases of the transmission signals TX1 to TX8 based on the third Hadamard matrix HM3.

According to some embodiments, the sensor driving unit 200C may use a Fourier matrix when the number of transmission signals TX1 to TX8 is not a multiple of 4 (2ⁿ).

FIG. 14 shows an example of the sum of the transmission signals TX1 to TX8 and the sensing signals SS.

The sensor driving unit 200C may provide the transmission signals TX1 to TX8, which a phase determined based on the third Hadamard matrix HM3 is applied, to the first electrodes TE1 to TE8 (see FIG. 6). In this case, the input detection circuit 200C3 may receive the sensing signals SS such as those shown in FIG. 14. In FIG. 14, the horizontal axis represents time, and the vertical axis represents amplitude.

In the example shown in FIGS. 8 and 9, the transmission signals TX1 to TX8 have the same amplitude and phase during the first section P1, so that the sum of the sensing signals SS in the first section P1 has a very large amplitude. The PAPR of the sum of the sensing signals SS in the first section P1 has a very large value.

In the example shown in FIG. 14, when the transmission signals TX1 to TX8, to which the power flattening phase has been applied, are provided to the first electrodes TE1 to TE8, the power (i.e., amplitude) is constant in the first to eighth sections P1 to P8, thus minimizing the PAPR of the sensing signals SS.

FIG. 15 is a diagram an example of the sum of the sensing signals SS received from a sensor when the transmission signals TX1 to TX8 having phases determined based on the third Hadamard matrix HM3 are provided to the sensor.

Referring to FIG. 15, the transmission signals TX1 to TX8 have phases corresponding to the third Hadamard matrix HM3 shown in FIG. 12 in the first to eighth sections P1 to P8.

Because the sum of the sensing signals SS has a constant maximum amplitude in the first to eighth sections P1 to P8, the PAPR of the sensing signals SS may be minimized.

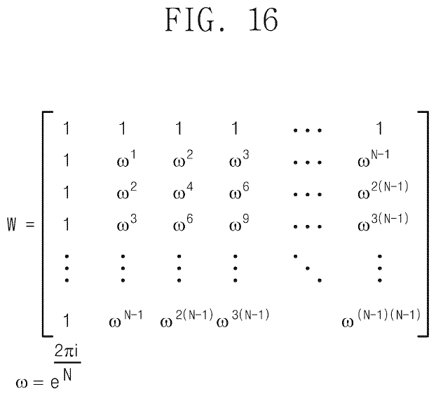

FIG. 16 is a diagram illustrating a Fourier matrix.

Referring to FIGS. 6 and 16, a Fourier matrix may be viewed as a complex Hadamard matrix in the complex range. The use of a Fourier matrix may minimize code design constraints (i.e., constraints on the number of the transmission signals TX1 to TX8).

Each element of the Fourier matrix W with a size of N×N shown in FIG. 16 may be calculated as shown in Equation 3.

$${[ {W}_{N} ]}_{jk} = exp [ 2 π i ( j - 1 ) ( k - 1 ) / N ] for j , k = 1 , 2 , ⋯ , N \qquad Equation 3$$

where, the size of the code N is a natural number.

The N×N Fourier matrix is shown in FIG. 16.

Similar to the third Hadamard matrix HM3 shown in FIG. 12, the row vectors of the Fourier matrix W are orthogonal to each other. Therefore, the transmission signals TX1 to TX8 may be converted by multiplying each row of the Fourier matrix W by a certain phase to relatively reduce the PAPR of the sensing signals SS.

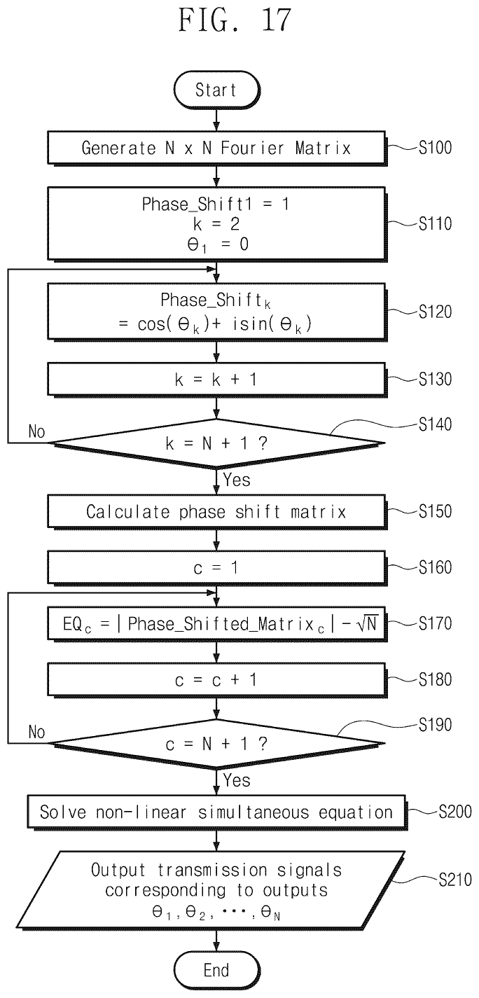

FIG. 17 is a flowchart illustrating the operation of the sensor driving unit 200C according to some embodiments of the present disclosure.

Referring to FIGS. 6 and 17, the sensor driving unit 200C may calculate power flattening phases (θ₁, θ₂, . . . , θ_{N}) for a Fourier matrix with a size of N×N.

The operation of the sensor driving unit 200C will be described based on CDM, but embodiments according to the present disclosure are not limited thereto. For example, the present disclosure may also be applied to MC-MFDM.

The sensor driving unit 200C may generate an N×N Fourier matrix (step S100). The N×N Fourier matrix may be as shown in FIG. 16.

In the complex domain, a phase shift by θ is defined as the product of e^{iθ}, which may be expressed as cos(θ)+i sin(θ) according to Euler's formula. Therefore, the phase shift value (phase_shiftₖ) to be multiplied by the k-th row of the Fourier matrix may be expressed as Equation 4.

$${phase\_shift}_{k} = cos ( {θ}_{k} ) + i sin ( {θ}_{k} ) for k = 1 , 2 , ⋯ , N \qquad Equation 4$$

Because no phase shift is applied to the first row of the Fourier matrix, the phase (θ₁) is assigned a value of 0 and the phase shift value (phase_shift₁) is assigned a value of 1.

Therefore, the sensor driving unit 200C may initially set a phase shift (phase_shift₁) to 1, k to 2 (k=2), and the power flattening phase (θ₁) to 0 (step S110).

The sensor driving unit 200C may calculate a phase shift value (phase_shiftₖ) according to Equation 4 (step S120).

The sensor driving unit 200C may increase the value of k by 1 (step S130).

The sensor driving unit 200C may determine whether the value of k is N+1 (step S140). The sensor driving unit 200C may calculate all the phase shift values (phase_shift₂, phase_shift₃, . . . , phase_shift_{N}) to be respectively multiplied by the “N” rows by repeatedly performing steps S120, S130, and S140 until the value of k becomes N+1.

After each row of the Fourier matrix (W) is multiplied by the phase shift value (phase_shiftₖ), when the column-wise sum of the matrix is called the phase shifted matrix (phase_shifted_matrixₖ), the phase shifted matrix (phase_shifted_matrixₖ) is as shown in Equation 5.

$$phase\_shifted {\_matrix}_{k} = {\sum }_{j = 1}^{N} {W}_{jk} \cdot {phase\_shift}_{J} for k = 1 , 2 , ⋯ , N \qquad Equation 5$$

where W is a Fourier matrix with a size of N×N as shown in FIG. 16, and phase_shiftⱼ is a phase shift value of the j-th row.

The sensor driving unit 200C may calculate the phase shifted matrix (phase_shifted_matrixₖ) of Equation 5 (step S150).

When a 1×N matrix including phase shift values (phase_shift₁, phase_shift₂, . . . , phase_shift_{N}) is called a row phase shift value (phase_shift), all values of the phase shifted matrix (phase_shifted_matrix) may be expressed as a matrix product of the row phase shift value (phase_shift) and the Fourier matrix (W), as shown in [Equation 6].

$$Phase\_shifted \_matrix = Phase\_shift \cdot W = [ {phase\_shift}_{1} {phase\_shift}_{2} ⋯ {phase\_shift}_{N} ] \cdot [ \begin{matrix}1 & 1 & 1 & 1 & ⋯ & 1 \\ 1 & {ω}^{1} & {ω}^{2} & {ω}^{3} & ⋯ & {ω}^{N - 1} \\ 1 & {ω}^{2} & {ω}^{4} & {ω}^{6} & ⋯ & {ω}^{2 ( N - 1 )} \\ 1 & {ω}^{3} & {ω}^{6} & {ω}^{9} & ⋯ & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & & {ω}^{( N - 1 ) ( N - 1 )}\end{matrix} ] \qquad Equation 6$$

When the absolute value of each element of the phase shifted matrix (phase_shifted_matrixₖ) obtained by Equation 6 is calculated, it is the same as the size of each sensing signal SS. The power flattening phase is a phase that makes each sensing signal SS have the same power, and may be power flattening phases (θ₁, θ₂, . . . , θ_{N}) that satisfy Equation 7.

$$Equation 7$$

$$\vert phase\_shifted {\_matrix}_{1} \vert = \vert phase\_shifted {\_matrix}_{2} \vert = … = \vert phase\_shifted {\_maxtrix}_{N - 1} \vert = \vert phase\_shifted {\_matrix}_{N} \vert$$

In this case, when the codes of the Fourier matrix (W) with a size of N×N have evenly-distributed power, a relationship as in Equation 8 is defined when power with a size of N is distributed per code.

$$Equation 8$$

$$\vert phase\_shifted {\_matrix}_{1} \vert = \vert phase\_shifted {\_matrix}_{2} \vert = … = \vert phase\_shifted {\_maxtrix}_{N - 1} \vert = \vert phase\_shifted {\_matrix}_{N} \vert = \sqrt{N}$$

Equation 8 may be expressed by a total of N simultaneous equations EQ₁, EQ₂, . . . , EQ_{N}.

The sensor driving unit 200C sets “c” to 1 (step S160).

The sensor driving unit 200C sets up a simultaneous equation EQc (step S170).

The simultaneous equation EQc is as shown in Equation 9 below.

$$EQc = \vert phase\_shifted {\_matrix}_{k} \vert - \sqrt{N} \qquad Equation 9$$

where “c” is 1, 2, . . . , N.

The sensor driving unit 200C increases “c” by 1 (step S180).

The sensor driving unit 200C determines whether “c” is N+1 (step S190).

The sensor driving unit 200C repeatedly performs steps S170, S180, and S190 until “c” becomes N+1. That is, the sensor driving unit 200C may set up N simultaneous equations EQ1, EQ2, . . . , EQN as in Equation 9 based on Equation 8.

Because no phase shift is applied to the first row of the Fourier matrix (W), the power flattening phase (θ₁) is 0. Therefore, when the nonlinear simultaneous equations for (N−1) power flattening phases (θ₂, θ₃, . . . , θ_{N}) excluding the power flattening phase (θ₁) are calculated, the sensor driving unit 200C may obtain the power flattening phases (θ₁, θ₂, . . . θ_{N}) of the Fourier matrix with a size of N×N (step S200).

The sensor driving unit 200C may output the transmission signals TX1 to TX8 to which the power flattening phases (θ₁, θ₂, . . . θ_{N}) have been applied (step S210). That is, the sensor driving unit 200C may output the transmission signals TX1 to TX8 that have been phase-shifted by the power flattening phases (θ₁, θ₂, . . . θ_{N}).

Despite of use of a Hadamard matrix, which is constrained in code size, and the complex domain, the power flattening technique may be applied to Fourier matrices that allow for the design of N×N codes for all natural numbers N. This ensures that for CDM and MC-MFDM signals meeting specific conditions, the minimum PAPR value is able to always be achieved without additional computation.

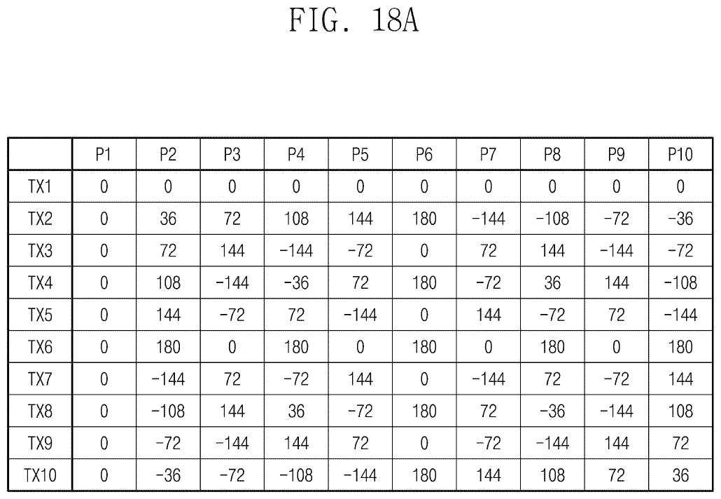

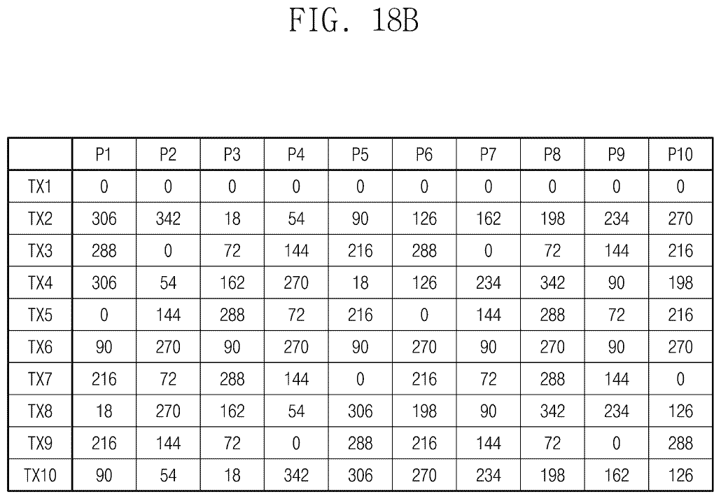

FIG. 18A is a diagram showing an example of phase shift values.

FIG. 18B is a diagram showing an example of phases of transmission signals TX1 to TX10.

In FIG. 6, it is assumed that the sensor 200 includes ten first electrodes (or transmission electrodes).

Referring to FIG. 6, FIG. 18A and FIG. 18B, the ten first electrodes of the sensor 200 may receive the transmission signals TX1 to TX10, respectively.

It is assumed that the power flattening phases (θ₁, θ₂, . . . θ₁₀) are determined as 0, 306, 288, 306, 0, 90, 216, 18, 216, and 90 by the operation of the sensor driving unit 200C illustrated in FIG. 17.

When the Fourier matrix has a size of 10×10, each row of the Fourier matrix may correspond to the transmission signals TX1 to TX10, respectively, and the columns of the Fourier matrix may correspond to the first to tenth sections P1 to P10, respectively.

The phase shift value may have a size of 10×10, similar to the Fourier matrix. The phase shift value may have a value between −180 and +180.

By adding the phase shift value shown in FIG. 18a to the power flattening phases (θ₁, θ₂, . . . θ₁₀), the phases of the transmission signals TX1 to TX10 may be determined. The phases of the transmission signals TX1 to TX10 may have a value between 0 and 360.

For example, in the first section P1, the phases of the transmission signals TX1 to TX10 are 0, 306, 288, 306, 0, 90, 216, 18, 216, and 90, obtained by adding phase shift values 0, 0, 0, 0, 0, 0, 0, 0, 0, 0, and 0, to 0, 306, 288, 306, 0, 90, 216, 18, 216, and 90, respectively.

In the second section P2, the phases of the transmission signals TX1 to TX10 are 0, 342, 0, 53, 144, 270, 72, 270, 144, and 54 obtained by adding 0, 306, 288, 306, 0, 90, 216, 18, 216, and 90, to the phase shift values 0, 36, 72, 108, 144, 180, −144, −18, −72, and −36, respectively.

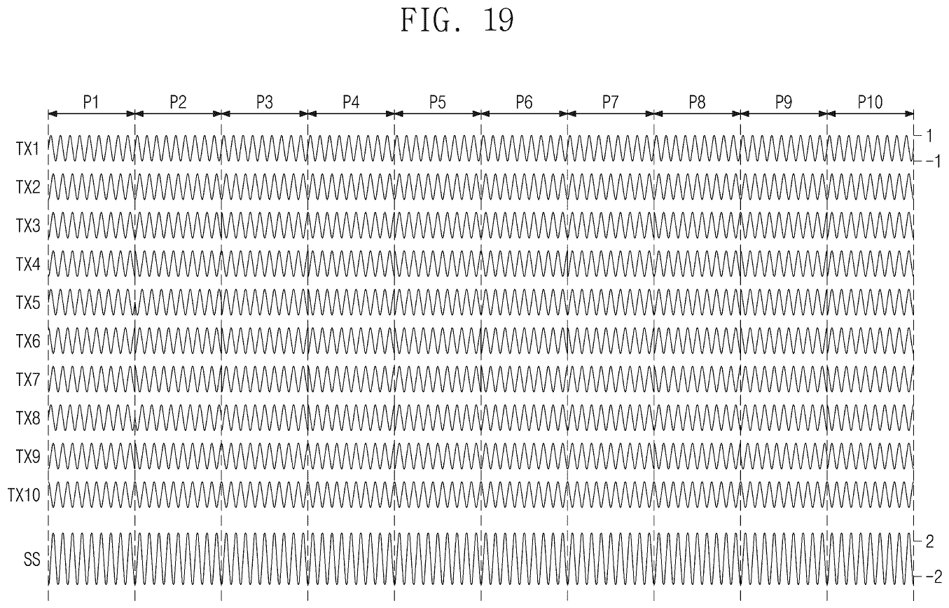

FIG. 19 shows an example of the sum of the transmission signals TX1 to TX10 and the sensing signals SS.

The sensor driving unit 200C may provide the transmission signals TX1 to TX10 to which the power flattening (θ₁, θ₂, . . . θ₁₀) determined based on the N×N Fourier matrix have been applied to the first electrodes. In this case, the input detection circuit 200C3 may receive the sensing signals SS as illustrated in FIG. 19. In FIG. 19, the horizontal axis represents time, and the vertical axis represents amplitude.

In the example illustrated in FIG. 19, when the transmission signals TX1 to TX10 to which the power flattening phases have been applied are provided to the first electrodes, the power (i.e., amplitude) of the sensing signals SS is constant in the first to tenth sections P1 to P10, thus minimizing the PAPR of the sensing signals SS.

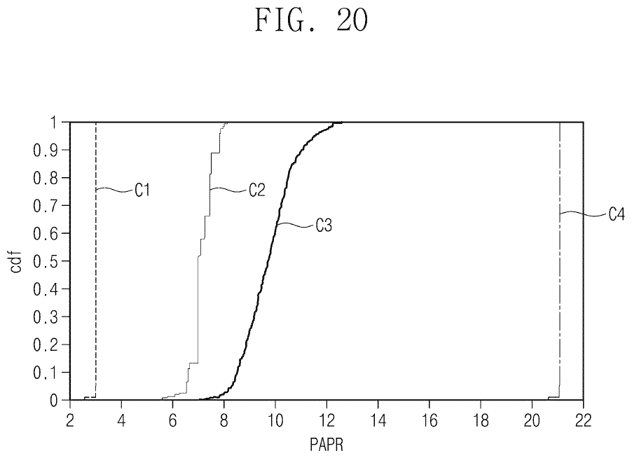

FIG. 20 is a graph showing an example of a cumulative distribution function cdf for the PAPR of the sensing signals SS.

FIG. 20 is a result of measuring the PAPR for the sensing signals SS when 64 transmission signals to which a Hadamard matrix with a size of 64×64 have applied are transmitted to the sensor 200 (see FIG. 6) in the CDM method after selecting a frequency in the range of 100 kHz to 500 kHz at 1 KHz intervals.

In FIG. 20, curve C1 represents PAPR for the sensing signals SS received in an electronic device to which the present disclosure is applied, and curves C2, C3, and C4 represent PAPR for the sensing signals SS received in other electronic devices to which the present disclosure is not applied, respectively.

It can be seen that the PAPR for sensing signals SS received in an electronic device to which the present disclosure is applied is always 3.0103 dB, regardless of the frequency of the transmission signals, which is the minimum PAPR that a sine wave is able to have.

An electronic device with the above-described configuration may minimize the signal-to-average ratio of the received signals by applying an appropriate phase to each of the transmitted signals. Therefore, the electronic device may detect a user's input relatively more accurately.

Although described above with reference to some embodiments, it will be understood by those skilled in the art that various modifications and changes may be made in the present disclosure without departing from the spirit and scope of the invention as set forth in the claims below. Furthermore, embodiments of the present disclosure are not intended to limit the technical spirit of embodiments according to the present disclosure. All technical spirits within the scope of the following claims and all equivalents thereof should be construed as being included within the scope of the present disclosure.

What is claimed is:

1. An electronic device comprising:
a display unit configured to display an image;
a sensor on the display unit; and
a sensor driving unit configured to provide a plurality of transmission signals to the sensor and to receive a plurality of sensing signals from the sensor,
wherein the sensor driving unit is configured to determine a power flattening phase for equally distributing power of the plurality of transmission signals, to assign the power flattening phase to the plurality of transmission signals, and to provide the plurality of transmission signals to the sensor.

2. The electronic device of claim 1, wherein the plurality of transmission signals has an identical maximum amplitude.

3. The electronic device of claim 1, wherein the power flattening phase is calculated by
$$θ = \{ \begin{matrix}Hadamard ( {2}^{k} ) , & n = 2 k \\ Hadamard ( {2}^{k} ) + iHadamard ( {2}^{k} ) , & n = 2 k + 1\end{matrix}$$
where “n” and “k” are each natural numbers, and Hadamard (2^{k}) has a second Hadamard matrix with a size of 2^{k}×2^{k}.

4. The electronic device of claim 3, wherein the sensor driving unit is configured to:
calculate a third Hadamard matrix based on a first Hadamard matrix with a size of 2ⁿ×2ⁿ and the second Hadamard matrix; and
determine a phase of each of the plurality of transmission signals based on the third Hadamard matrix.

5. The electronic device of claim 4, wherein the third Hadamard matrix with a size of 2³×2³ is
$$[ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ - 1 & 1 & 1 & - 1 & - 1 & 1 & 1 & - 1 \\ i & i & i & i & i & i & i & i \\ i & - i & i & - i & i & - i & i & - i \\ i & i & - i & - i & i & i & - i & - i \\ - i & i & i & - i & - i & i & i & - i\end{matrix} ] .$$

6. The electronic device of claim 1, wherein the sensor driving unit is configured to:
generate an N×N Fourier matrix;
calculate a phase shifted matrix by applying a phase shift to each row of the N×N Fourier matrix;
generate N simultaneous equations based on the phase shifted matrix;
calculate a plurality of power flattening phases based on the N simultaneous equations; and
assign the plurality of power flattening phases to the plurality of transmission signals, respectively, to provide the plurality of transmission signals to the sensor.

7. The electronic device of claim 6, wherein the N×N Fourier matrix is
$$[ \begin{matrix}1 & 1 & 1 & 1 & … & 1 \\ 1 & {ω}^{1} & {ω}^{2} & {ω}^{3} & … & {ω}^{N - 1} \\ 1 & {ω}^{2} & {ω}^{4} & {ω}^{6} & … & {ω}^{2 ( N - 1 )} \\ 1 & {ω}^{3} & {ω}^{6} & {ω}^{9} & … & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & & {ω}^{( N - 1 ) ( N - 1 )}\end{matrix} ]$$
$$where ω = {e}^{\frac{2 π i}{N}}$$

8. The electronic device of claim 7, wherein a phase shift value corresponding to each of “N” rows of the N×N Fourier matrix is
$${phase\_shift}_{k} = cos ( {θ}_{k} ) + i sin ( {θ}_{k} ) for k = 1 , 2 , … , N .$$

9. The electronic device of claim 8, wherein the phase shifted matrix is
$$phase\_shifted {\_matrix}_{k} = {\sum }_{j = 1}^{N} {W}_{jk} \cdot {phase\_shift}_{j} fork = 1 , 2 , … , N$$
where “W” is the N×N Fourier matrix, and phase_shiftⱼ is the phase shift value of a j-th row.

10. The electronic device of claim 9, wherein the sensor driving unit is configured to calculate the plurality of power flattening phases satisfying
$$\vert phase\_shifted {\_matrix}_{1} \vert = \vert phase\_shifted {\_matrix}_{2} \vert = … = \vert phase\_shifted {\_maxtrix}_{N - 1} \vert = \vert phase\_shifted {\_matrix}_{N} \vert .$$

11. The electronic device of claim 10, wherein a c-th simultaneous equation of the “N” simultaneous equations is
$$EQc = \vert phase\_shifted {\_matrix}_{k} \vert - \sqrt{N}$$
where “c” is 1, 2, . . . , N.

12. An input detecting method of an electronic device comprising:
generating an N×N Fourier matrix;
calculating a phase shifted matrix by applying a phase shift to each row of the N×N Fourier matrix;
generating N simultaneous equations based on the phase shifted matrix;
calculating a plurality of power flattening phases based on the N simultaneous equations; and
assigning the plurality of power flattening phases to the plurality of transmission signals, respectively, to provide the plurality of transmission signals to a sensor; and
receiving sensing signals from the sensor.

13. The input detecting method of claim 12, wherein the N×N Fourier matrix is
$$[ \begin{matrix}1 & 1 & 1 & 1 & … & 1 \\ 1 & {ω}^{1} & {ω}^{2} & {ω}^{3} & … & {ω}^{N - 1} \\ 1 & {ω}^{2} & {ω}^{4} & {ω}^{6} & … & {ω}^{2 ( N - 1 )} \\ 1 & {ω}^{3} & {ω}^{6} & {ω}^{9} & … & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & & {ω}^{( N - 1 ) ( N - 1 )}\end{matrix} ]$$
$$where ω = {e}^{\frac{2 π i}{N}} .$$

14. The input detecting method of claim 13, wherein a phase shift value corresponding to each of “N” rows of the N×N Fourier matrix is
$${phase\_shift}_{k} = cos ( {θ}_{k} ) + i sin ( {θ}_{k} ) for k = 1 , 2 , … , N .$$

15. The input detecting method of claim 13, wherein the phase shifted matrix is
$$phase\_shifted {\_matrix}_{k} = {\sum }_{j = 1}^{N} {W}_{jk} \cdot {phase\_shift}_{j} fork = 1 , 2 , … , N$$
where “W” is the N×N Fourier matrix, and phase_shift; is the phase shift value of a j-th row.

16. The input detecting method of claim 15, wherein the calculating of the plurality of power flattening phases includes calculating the power flattening phases satisfying
$$\vert phase\_shifted {\_matrix}_{1} \vert = \vert phase\_shifted {\_matrix}_{2} \vert = … = \vert phase\_shifted {\_maxtrix}_{N - 1} \vert = \vert phase\_shifted {\_matrix}_{N} \vert .$$

17. The input detecting method of claim 16, wherein a c-th simultaneous equation of the “N” simultaneous equations is
$$EQc = \vert phase\_shifted {\_matrix}_{k} \vert - \sqrt{N}$$
where “c” is 1, 2, . . . , N.
